(19) United States
(12) Patent Application Publication
(10) Pub. No.: US 2008/0133221 A1
(43) Pub. Date: Jun. 5, 2008

(54) THREAT ASSESSMENT BASED ON WRITTEN COMMUNICATION

(76) Inventor: Sharon S. Smith, Fredericksburg, VA (US)

Correspondence Address: KING & SCHICKLI, PLLC, 247 NORTH BROADWAY, LEXINGTON, KY, 40507, US

(21) Appl. No.: 11/749,781

(22) Filed: May 17, 2007

Related U.S. Application Data
(60) Provisional application No. 60/800,940, filed on May 17, 2006.

(51) Int. Cl. G06F 17/27

(52) U.S. Cl. 704/9

(57) ABSTRACT

A method for assessing risk of a harmful outcome includes obtaining at least one writing containing a threat directed to a target by an author of the writing. The method includes the further steps of identifying at least one outcome-predictive language use strategy, at least one outcome-predictive document feature, and at least one outcome-predictive psychological characteristic of the author. These variables are used to generate a numerical value predictive of a harmful outcome, that is, the author carrying out the threat. The present method may be used to predict risk of a harmful outcome from a single writing. In one aspect, the present method provides a formula predictive of risk of a harmful outcome based on analysis of at least one writing.

This application claims the benefit of priority to U.S. Provisional Patent Application Ser. No. 60/800,940, filed on May 17, 2006, the disclosure of which is incorporated herein in its entirety by reference.

### TECHNICAL HELD

The present invention relates to methods and systems for assessing severity of a threat based on written materials. In particular, the invention relates to methods and systems for assessing threat severity based on a single written communication issued from the author or threatener to a target.

### BACKGROUND OF THE INVENTION

Individuals, corporations, and buildings are frequently targets of written, telephone, email, and personal threats. Threats can be a factor in many categories of crimes, such as product tampering, extortion, bombing, domestic violence, stalking, and murder. Law enforcement agencies and private security firms that investigate these cases face three major challenges: (1) assessing threatener characteristics that relate to dangerousness; (2) predicting whether or not targeted violence is likely to occur; and (3) using those reliable and valid predictors as an aid in identifying and apprehending the threatener. Once investigators make these predictions and assessments, they must decide how best to protect potential targets. Their decisions may require extensive personnel resources and large expenditures of money, and therefore it is critical that assessments and predictions be as accurate as possible.

In keeping with this goal of making accurate threat assessments/predictions, law enforcement agencies have recognized the value of identifying salient factors for “risk of targeted violence” and “offender characteristics” ((Baumgartner, J. V., Scalora, M. J., & Plank, G. L. (2001). Case characteristics of threats toward state government targets investigated by a midwestern state. Journal of Threat Assessment, 1(3), 41-60)). Certain prior art methods have examined social, demographic, and psychopathological characteristics of threateners by grouping them according to the types of crimes the threatener commits or vows to commit, such as stalking ((Zona, M. A., Palarea, R. E., & Lane, J. C., Jr. (1998). Psychiatric diagnosis and the offender-victim typology of stalking. In J. R. Meloy (Ed.), The psychology of stalking: Clinical and forensic perspectives (pp. 69-84). San Diego: Academic Press)). Others have focused on the types of targets chosen, such as political figures ((Fein, R. A., & Vossekuil, B. (1999). Assassination in the United States: An operational study of recent assassins, attackers, and near-lethal approachers. Journal of Forensic Sciences, 44(2), 321-333)) or judicial officials ((Calhoun, F. S. (1998). Hunters and howlers: Threats and Violence against federal judicial officials. Arlington, Va.: United States Marshals Service)). It is also known in the prior art to link mental and personality disorders with the likelihood of violent behavior ((Monaban, J., Steadman, H. J., Silver, E., Appelbaum, P. S., Robbins, P. C., Mulvey, E. P., Roth, L. H., Grisso, R., & Banks, S. (2001). Rethinking risk assessment: The MacArthur study of mental disorder and violence. New York: Oxford University Press; Comer, R. J. (1998). Abnormal Psychology, (3rd ed.). New York: W. J. Freeman and Company)).

The prior art methodologies briefly discussed above are in general effective for their intended purpose. However, they require that significant information about the threatener be available to the investigating officer/agent or agency. Often, this is not the case, as the only information available in many threat cases is an initial threatening communication from a previously unknown individual, severely restricting the ability to assess mental or personality disorders. Indeed, in many threat cases, the first threatening communication is the only source of information available, from which investigators must expeditiously make decisions during the initial phase of an investigation. Initial efforts relating to analysis of written threat communications concentrated mainly on specific verbiage and stylistic features of the communication (Dietz, P. E., Matthews, D. B., Van Duyne, C., Martell, D. A., Parry, C. D. J., Stewart, T., Warren, J., & Crowder, J. D. (1991). Threatening and otherwise inappropriate letters to Hollywood celebrities. Journal of Forensic Sciences, 36(11), 185-209; Dietz, P. E., Matthews, D. B., Martell, D. A., Stewart, T. M., Hrouda, B. A., & Warren, J. (1991). Threatening and otherwise inappropriate letters to members of the United States Congress. Journal of Forensic Sciences, 36(5), 1445-1468)). More recent studies indicate that the ways in which an individual uses language can be associated with psychopathological disorders and dispositional characteristics, and linked with violent behavior. Such studies have led to Gottschalk and Bechtel's software program called PCAD 2000 (Psychiatric Content Analysis and Diagnosis), which uses content analysis to identify psychological states ((Gottschalk, L. A. & Bechtel, R. J. (2001). PCAD 2000: Psychiatric content analysis and diagnosis. Available from GB Software, Corona del Mar, Calif.)), and Hermann's ((Hermann, M. G. (2003). Assessing leadership style: Trait analysis. In J. M. Post (Ed.), The psychological assessment of political leaders with profiles of Saddam Hussein and Bill Clinton (pp. 178-212). Ann Arbor, Mich.: The University of Michigan Press)) methodology for measuring personality characteristics from language use, which is the basis of a computer content analysis system called Profiler Plus or Profiler+((Young, M. D. (2001). Building world view(s) with Profiler+. In M. D. West (Ed.), Applications of computer content analysis (pp. 17-32). Westport, Conn.: Ablex Publishing)).

However, known prior art methods for analyzing written communications to assess threat risk suffer from particular limitations. For example, many prior art methods focus on threats to individuals, when in fact threats may extend to particular institutions and objects. Still further, studies analyzing threats to individuals often focus on specialized groups of individuals, such as politicians, celebrities, and the like, rather than on the “general public.” Other methods are limited to specific types of crimes, for example violent crimes, and may not be useful in assessing the risk of other types of crimes, such as non-violent crimes or actions which, while not resulting in physical harm, may cause significant mental distress to the victim.

Most tellingly, many of the prior art methods relating to threat-related risk assessment rely on retrospective analysis of characteristics of known threateners and on using these characteristics as predictive tools. As discussed above, in risk assessment based on written communication, law enforcement agencies may simply not have access to the identity of the as yet unknown threatener, rendering such methods of limited use.

There is accordingly a need in the art for methods of threat-related risk assessment which do not rely on availability of detailed information regarding the threatener, and which extend not only to the general public (as well as high profile individuals) but also to institutions and objects. In particular, there remains a need in the art for methods of threat-related risk assessment which are based on written communications, even a single writing, which often is the only information available to law enforcement during the initial phases of an investigation. Such methods would allow law enforcement to target resources to cases involving written threats such as a single writing which present the highest risk of action on the part of the threatener, i.e., harm to the threatened person, institution, or object.

### SUMMARY OF THE INVENTION

In accordance with the foregoing identified need in the art, the present invention provides a method for assessing a risk of a harmful outcome from at least one writing containing a threat directed to a target by an author of the writing. The method of the present invention comprises identifying at least one outcome-predictive language use strategy in the writing, at least one outcome-predictive communication strategy directed from the author to the target, at least one outcome-predictive document feature, and at least one outcome-predictive psychological characteristic of the author from the content of the writing. Numerical values are then assigned to the at least one language use strategy, at least one communication strategy, at least one document feature, and at least one psychological characteristic.

From these numerical values, the present inventor has surprisingly found that a numerical value predictive of a harmful outcome may be generated, allowing entities such as law enforcement agencies to more accurately identify threateners likely to carry out their threat and to more efficiently target resources for dealing with the threat. Advantageously, the method of the present invention allows prediction of a harmful outcome from a single writing, which in many cases is the only threat indicator possessed by law enforcement.

In one embodiment of the present invention, the at least one language use strategy may comprise one or more of use of words indicative of a religious prejudice (LQ26), use of words indicative of love, marriage, or romance directed to the target (LQ62), use of words indicative of a polite tone by the author (LQ60), an implicit or explicit indication of the target of the threat (LQ17), and a specific indication of a weapon for carrying out the threat (LQ14). The at least one psychological characteristic may comprise one or more of a measure of conceptual complexity of the author (CC) and a measure of ambivalent hostility of the author (PCAD18). In particular embodiments of the invention, the at least one psychological characteristic of the author may be quantified using a prior art automated writing analyzer such as Profiler Plus, PCAD, and the like.

The at least one communication strategy comprises at least one additional communication (LQ24) directed from the author to the target, which may be one or more of an email communication, a telephone communication, and the like. The at least one document feature may be the author's providing a correct partial or complete return address for the author (LQ43).

In a particular embodiment of the present invention, prediction of a harmful outcome from at least one writing is provided in accordance with the general formula:

$$p = \frac{{e}^{y}}{1 + {e}^{y}}$$

wherein p is the probability of the threatener taking action, e is the base of natural logarithm (2.71828), and y=11.2607+(3.5635×CC)−(10.5651×PCAD18)−(10.2594×LQ26)+(1.2062×LQ60)+(12.7267×LQ62)+(0.6726×LQ17)−(11.8110×LQ43)+(1.1225×LQ24)−(1.2740×LQ14). The identified variables are as set forth above.

Of course, the skilled artisan will realize that the method of the present invention is readily adaptable to a variety of computer-implemented formats, including the source code and software for implementing such. For example, computer-executable code stored on a computer-readable medium for implementing the method is readily appreciable. Still further, any number of adaptations of the method are contemplated, such as providing computer-executable instructions on any currently known or to be developed computer-readable medium for accomplishing the method, by providing software comprising such computer-executable instructions by direct electronic transmission to a user, or made accessible to a user via the Internet, via an intranet, or the like. All such adaptations are contemplated herein.

As should be appreciated, the embodiments shown and described herein are an illustration of one of the modes best suited to carry out the invention. It will be realized that the invention is capable of other different embodiments and its several details are capable of modification in various, obvious aspects all without departing from the invention. Accordingly, the descriptions herein will be regarded as illustrative in nature, and not as restrictive.

### DETAILED DESCRIPTION OF THE INVENTION

The following description and examples are presented in support of and to further illustrate the invention as described herein. However, the invention is not to be considered as limited thereto. The citations of literature referred to herein are understood to form a part of this disclosure, and are incorporated in their entirety by reference.

As used herein, target means the person, property, or entity being threatened. Victim means the person, property, or entity actually harmed. The victim and target may or may not be the same, e.g., the threatener may have written a letter in which he threatened a target, but burned down the house of a relative of the target. A threatening communication means any written information delivered to targets/victims or agents acting on their behalf. Threatening communications may be in the form of letters, cards, or notes, but may also include diaries or packages which contain multiple communications. Personal visits, telephone calls, and other means of contact (considered herein to be “additional communications”) were measured as separate variables.

Data used in developing and testing the present invention were derived from a database consisting of cases the Federal Bureau of Investigation's (FBI) National Center for the Analysis of Violent Crime (NCAVC) analyzed and then closed during 1997 and 1998 (closed cases are defined for purposes of the present disclosure as NCAVC completing its analysis). A correlational design was used that compared variables gathered through an interview questionnaire and two prior art automated instruments (PCAD and Profiler Plus). The purpose was to measure the interrelationships between the action taken by a threatener and characteristics of the (a) threatener, (b) target/victim, and (c) threatening communication and methods used to communicate the threat.

An interview protocol was developed for accessing case-related information concerning three categories of independent variables and one dependent variable. The independent variable categories considered were (1) social, demographic, and psychological characteristics of the threatener, (2) target/victim type and relationship with threatener (e.g., strangers or co-workers), and (3) language use and document features of the threat and methods used to communicate the threat (referred to hereinafter as the language use protocol). The dependent variable was case outcome—“action taken” by the threatener. Action taken was coded as: (1) no action; and (2) action.

The threatening communications were also analyzed by two prior art computerized text coding programs (Profiler Plus and PCAD). Both programs evaluate personality characteristics from language use information. The list and definitions of characteristics measured by each computer program are known in the art.

Once the language use protocol sheets were scored (item 3 above), they were scanned and all scores were electronically entered into a spreadsheet database (SPSS, Chicago, Ill.). The threatening communications were typed, and then scored using Profiler Plus and PCAD. Profiler Plus and PCAD scoring data for the writings were then electronically added to the database.

Pearson product-moment correlations were calculated for relationships between independent and dependent (outcome) variables, which at this stage included independent variables relating to the threatener and the target. Multiple regression was used to rank order predictors from each category of independent variables; then logistical regression was used to construct a predictive equation from salient independent variables.

Several language use features, document features, and methods used to communicate threats in the writings were initially identified as associated with threateners acting, and analyzed to ascertain which were correlated with action. Those elements are set forth in Table 1.

TABLE 1
Language use variables associated with action taken

| | Pearson |
|---|---|
| Language use variable | i. Correlation |
| Threatening to reveal detrimental information | .25048* |
| (whether true or false) | |
| Threatening to stalk | .23901* |
| Using persuasion in threatening communication | .20634* |
| Repeatedly mentioning love, marriage, or romance | .35139*** |
| Tone of threatening communication is polite | .26225** |
| Use of words indicating prejudices concerning religion | −.20234* |

Note
*p < .05;
**p < .01;
***p < .001.

Threateners were significantly more likely to approach/stalk or harm when they used the language use strategy of persuasion in their threat communications (r=0.20634, p=0.0437), while the strategy of extorting only approached significance (r=0.17823, p=0.0823). Threateners were also significantly more likely to act when they asserted they would commit two types of actions: stalking (r=0.23901, p=0.0190) and revealing detrimental information, whether true/or false (r=0.25048, p=0.0138). On the other hand, threateners indicating what or who was to be targeted, either explicitly or implicitly, were associated with increased risk, but that association only approached significance (r=0.18241, p=0.0768).

It was also found that threateners were more likely to act when they repeatedly used words indicative of love, marriage, or romance (r=0.35139, p=0.0004). This supported the Dietz, Matthews, Van Duyne, et al.'s (1991) celebrity study finding. Moreover, threateners were also significantly more likely to act when the tone of the threatening communication was polite (r=0.26225, p=0.0098), also supporting what Dietz, Matthews, Martell, et al. (1991) found in their threats to members of Congress study. One correlation with action in this current research (that approached significance) was threateners indicating they were thinking about being with the target “forever” or “in eternity” (r=0.17290, p=0.0921). Conversely, threateners were significantly less likely to act if they used words indicating prejudices concerning religion (r=−0.20234, p=0.0480). Words indicating prejudices concerning race, gender, sexual preference, and ethnicity had no relationship to action.

Certain document features were associated with harming and approaching or stalking. Those features are presented below in Table 2.

TABLE 2
Document features associated with action taken

| | Pearson |
|---|---|
| Document features | i. Correlation |
| Threat was handwritten | .21286* |
| Use of inappropriate capitalization | −.20447* |
| Threateners provided true return address | −.22900* |
| (partial or complete) | |
| Threat typed on typewriter, not computer | −.23513* |

Note
*p < .05.

Threateners were significantly more likely to act if they handwrote the threat (r=0.21286, p=0.0373), but significantly less likely to act if they used inappropriate capitalization (r=−0.20447, p=0.0469), typed their threats on a typewriter rather than a computer (r=−0.23513, p=0.0233), or gave their real return address, either partial or complete (r=−0.229, p=0.0329). The latter finding supported the Dietz, Matthews, Van Duyne, et al.'s (1991) findings on celebrity threats. Finally, threateners in the current study were significantly more likely to act when they communicated with targets through multiple mediums, such as calling or emailing the target, in addition to sending their threatening communication (r=0.31898, p=0.0017). This association was also found in studies of threats to members of Congress ((Dietz, Matthews, Martell, et al., 1991; Scalora, M. J., Baumgartner, J. V., Zimmerman, W., Callaway, D., Maillette, M. A. J., Covell, C. N., Palarea, R. E., Krebs, J. A., & Washington, D. 0. (2002a). Risk factors for approach behavior toward the U.S. Congress. Journal of Threat Assessment, 2(2), 35-55)) and threats to celebrities (Dietz, Matthews, Van Duyne, et al., 1991).

Next, multiple regression was used to rank order variables within each category according to association with outcome. After all salient variables were rank ordered within their various categories, logical regression analysis was used to select the best predictors from the rank-ordered variables for the purpose of constructing an equation to differentiate between threateners who acted and those who did not (see Table 3).

TABLE 3
Predictive equation variables and their beta weights

| | | β | Wald |
|---|---|---|---|
| Variables | df | i. Chi-Square | |
| Intercept | 1 | 11.2607 | 0.0006 |
| Conceptual complexity (CC) | 1 | 3.5635 | 2.0848 |
| Ambivalent hostility (PCAD 18) | 1 | −10.5651 | 2.7527 |
| Words indicating religious prejudices (LQ26) | 1 | −10.2594 | 0.0046 |
| Polite tone (LQ60) | 1 | 1.2062 | 1.6135 |
| Mentioning love, marriage, or romance (LQ62) | 1 | 12.7267 | 0.0009 |
| Indicating target/victim, explicitly or implicitly | 1 | 0.6726 | 0.4558 |
| (LQ17) | | | |
| Giving correct full or partial return address | 1 | −11.8110 | 0.0077 |
| (LQ43) | | | |
| Communicating through multiple mediums | 1 | 1.1225 | 1.8577 |
| (LQ24) | | | |
| Specifying weapons (LQ14) | 1 | −1.2740 | 2.5686 |

With reference to Table 3, the variables (and their designators) selected for use in the predictive equation based on logical regression analysis as described above were: (1) conceptual complexity (CC; quantitated using Profiler Plus and defined herein as the ability to recognize that others might have different positions, values, ideas, or policies), (2) ambivalent hostility (PCAD 18; quantitated using PCAD and defined herein as paranoia, or the critical, destructive actions or thoughts of others directed toward self), (3) using words indicating prejudices concerning religion (LQ26), (4) using polite tone in the threatening communication (LQ60), (5) mentioning love, marriage, or romance (LQ62), (6) indicating or identifying the target/victim, either explicitly or implicitly, in the threatening communication (LQ17), (7) threateners giving their real return address (partial or complete) (LQ43), (8) threateners communicating with the target/victim through multiple mediums (LQ24), and (9) threateners specifying weapons in the threatening communication (LQ14). The selected variables (specifically, the values assigned to each selected variable in the analysis) were assigned beta weights in accordance with their relative importance to the equation, as is known in the art of predictive regression analysis.

The first step in the predictive model was calculating y from the following equation composed of the selected variable values and their beta weights:

y=11.2607+(3.5635×CC)−(10.5651×PCAD18)−(10.2594×LQ26)+(1.2062×LQ60)+(12.7267×LQ62)+(0.6726×LQ17)−(11.8110×LQ43)+(1.1225×LQ24)−(1.2740×LQ14).

The value calculated for y was used as the exponent in the second step, which entails calculating the probability of threateners taking action from the equation:

$$p = \frac{{e}^{y}}{1 + {e}^{y}}$$

where p=the probability of the threatener taking action (probability score), and e=the base of natural logarithm. This value is a constant always equal to approximately 2.71828.

Scores for p will range from 0.00 to 1.00. This predictive model correctly classified 68 cases of the 96 cases (70.8%). The five incorrectly classified cases (1 false positive and 4 false negatives) constituted 5.3% and 23 cases could not be classified (24.2%) (see Table 4).

TABLE 4
Predictive equation success rate by probability score groups

| | | | N of cases | | |
|---|---|---|---|---|---|
| Probability | | | correctly | False | False |
| scores | Prediction | N of cases | predicted | positives | negatives |
| .00-.19 | No action | 59 | 55** | 0 | 4 |
| .20-.49 | Can't be | 23 | NA* | NA* | NA* |
| | predicted | | | | |
| .50-1.00 | Action | 14 | 13*** | 1 | 0 |

*NA—Not applicable
**93.2% correctly predicted in .00-.19 probability score range
***92.8% correctly predicted in .50-1.00 probability score range

Dividing the cases into three groups according to their probability scores dramatically improved the equation success rate predictions (see Table 4). Assuming cases with probability scores of 0.00-0.19 were predicted to be no action, the equation correctly predicted 55 of the 59 cases that fell in this range (93.2% correct prediction rate), with 4 false negatives. Assuming cases with probability scores of 0.5-1.00 were predicted to be action cases, then the equation correctly predicted 13 of these 14 cases (92.8% correct prediction rate), with one false positive. The 23 cases that fell in the range of 0.20 to 0.49 could not be predicted (24.2%).

The value of the present invention will thus immediately be appreciated by the skilled artisan. Unlike other risk assessment areas, threatening communication cases do not begin with a known person in custody. The only available information is often a single threatening communication, and on this basis law enforcement must make risk assessments and decisions about deploying limited manpower and resources. The present invention therefore provides a method for identifying the presence of predatory thinking in threatening communications, as a factor for assessing risk of action by the threatener. Accordingly, investigators are provided with an important tool for more accurately assessing when threateners are planning to move from violent words to violent deeds.

Additional advantages, and other novel features of the invention will become apparent to those skilled in the art upon examination of the foregoing disclosure, or may be learned with practice of the invention. For example, it will be easily appreciated by the skilled artisan that the present invention contemplates use for risk assessment in other areas, such as decision-making by clinicians who must decide whether to release or commit a potentially mentally ill individual, or parole boards considering parole for a convicted felon. Analysis of a writing or writings (e.g., diaries, letters, e-mails) of such individuals in accordance with the present invention may further increase predictive ability; and therefore further inform, for example, a decision to release or commit such individuals.

The foregoing description of the preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments with various modifications as are suited to the particular use contemplated. All such modifications and variations are within the scope of the invention as determined by the disclosure, the appended Exhibits, and the appended claims when interpreted in accordance with the breadth to which they are fairly, legally, and equitably entitled.

What is claimed is:

1. A method for assessing a risk of a harmful outcome, comprising:
obtaining at least one writing containing a threat directed to a target by an author of the writing;
identifying at least one outcome-predictive language use strategy, and assigning a numerical value to the at least one linguistic strategy;
identifying in the writing at least one outcome-predictive communication strategy directed from the author to the target, and assigning a numerical value to the at least one communication strategy;
identifying in the writing at least one outcome-predictive document feature, and assigning a numerical value to the at least one document feature;
identifying from a content of the writing at least one outcome-predictive psychological characteristic of the author, and assigning a numerical value to the at least one psychological characteristic; and
generating a numerical value predictive of a harmful outcome from the at least one language use strategy numerical value, the at least one communication strategy numerical value, the at least one document feature numerical value, and the at least one psychological characteristic numerical value.

2. The method of claim 1, wherein the step of generating a numerical value predictive of a harmful outcome is based on a single writing.

3. The method of claim 1, wherein the at least one language use strategy comprises use of words indicative of a religious prejudice (LQ26).

4. The method of claim 1, wherein the at least one language use strategy comprises use of words indicative of love, marriage, or romance directed to the target (LQ62).

5. The method of claim 1, wherein the at least one language use strategy comprises use of words indicative of a polite tone by the author (LQ60).

6. The method of claim 1, wherein the at least one language use strategy comprises an implicit or explicit indication of the target of the threat (LQ17).

7. The method of claim 1, wherein the at least one language use strategy comprises a specific indication of a weapon for carrying out the threat (LQ14).

8. The method of claim 1, wherein the at least one psychological characteristic comprises a measure of conceptual complexity of the author (CC).

9. The method of claim 1, wherein the at least one psychological characteristic comprises a measure of ambivalent hostility of the author (PCAD18).

10. The method of claim 8, wherein the at least one psychological characteristic value is assigned using an automated writing analyzer.

11. The method of claim 9, wherein the at least one psychological characteristic value is assigned using an automated writing analyzer

12. The method of claim 1, wherein the at least one communication strategy comprises at least one additional communication from the author to the target (LQ24).

13. The method of claim 12, wherein the at least one additional communication comprises one or more of an email communication and a telephone communication.

14. The method of claim 1, wherein the at least one document feature comprises providing a correct partial or complete return address for the author (LQ43);

15. The method of claim 1, wherein the prediction of harmful outcome is generated in accordance with the formula:
$$p = \frac{{e}^{y}}{1 + {e}^{y}}$$
wherein p is the probability of the threatener taking action, e is the base of natural logarithm (2.71828), and y=11.2607+(3.5635×CC)−(10.5651×PCAD18)−(10.2594×LQ26)+(1.2062×LQ60)+(12.7267×LQ62)+(0.6726×LQ17)−(11.8110×LQ43)+(1.1225×LQ24)−(1.2740×LQ14).

16. A computer-implemented method for assessing a risk of a harmful outcome, comprising:
obtaining at least one writing containing a threat to a target by an author of the writing;
identifying at least one outcome-predictive language use strategy in the writing, said linguistic strategy comprising at least one of:
(i) use of words indicative of a religious prejudice (LQ26);
(ii) use of words indicative of love, marriage, or romance directed to the target (LQ62);
(iii) use of words indicative of a polite tone by the author (LQ60);
(iv) use of words indicative of an implicit or explicit indication of the target of the threat (LQ17); and
(v) use of words identifying a specific weapon for carrying out the threat (LQ14);
identifying in the writing at least one outcome-predictive communication strategy directed from the author to the target, consisting of at least one additional communication from the author to the target (LQ24);
identifying in the writing at least one outcome-predictive document feature, consisting of providing a correct partial or complete return address for the author (LQ43);
identifying from a content of the writing at least one outcome-predictive psychological characteristic of the author, said psychological characteristic comprising at least one of a measure of conceptual complexity of the author (CC) and a measure of ambivalent hostility of the author (PCAD18);
assigning a numerical value to the at least one language use strategy, at least one communication strategy, the at least one document feature, and at least one psychological characteristic; and
generating a numerical value predictive of a harmful outcome from the numerical values.

17. The method of claim 16, wherein the step of generating a numerical value predictive of a harmful outcome is based on a single writing.

18. The method of claim 16, wherein the at least one psychological characteristic value is assigned using an automated writing analyzer.

19. The method of claim 16, wherein the at least one additional communication comprises one or more of an email communication and a telephone communication.

20. The method of claim 16, wherein the prediction of outcome is generated in accordance with the formula:
$$p = \frac{{e}^{y}}{1 + {e}^{y}}$$
wherein p is the probability of the threatener taking action, e is the base of natural logarithm (2.71828), and y=11.2607+(3.5635×CC)−(10.5651×PCAD18)−(10.2594×LQ26)+(1.2062×LQ60)+(12.7267×LQ62)+(0.6726×LQ17)−(11.8110×LQ43)+(1.1225×LQ24)−(1.2740×LQ14).

21. A method for assessing a risk of a harmful outcome, comprising obtaining at least one writing containing a threat to a target by an author of the writing; and
generating a numerical value predictive of harmful outcome in accordance with the formula:
$$p = \frac{{e}^{y}}{1 + {e}^{y}}$$
wherein p is the probability of the threatener taking action, e is the base of natural logarithm (2.71828), and y=11.2607+(3.5635×CC)−(10.5651×PCAD18)−(10.2594×LQ26)+(1.2062×LQ60)+(12.7267×LQ62)+(0.6726×LQ17)−(11.8110×LQ43)+(1.1225×LQ24)−(1.2740×LQ14);
further wherein CC is a numerical value assigned to a measure of conceptual complexity of the author, PCAD18 is a numerical value assigned to a measure of ambivalent hostility of the author, LQ26 is a numerical value assigned to use of words in the writing indicative of a religious prejudice, LQ60 is a numerical value assigned to use of words in the writing indicative of a polite tone by the author, LQ62 is a numerical value assigned to use of words in the writing indicative of love, marriage, or romance directed to the target, LQ17 is a numerical value assigned to use of words in the writing indicative of an implicit or explicit indication of the target of the threat, LQ43 is a numerical value assigned to use of words in the writing providing the author's partial or complete return address, LQ24 is a numerical value assigned to use of a communication strategy consisting of at least one additional communication from the author to the target, and LQ14 is a numerical value assigned to use of words in the writing use of words identifying a specific weapon for carrying out the threat.

22. The method of claim 21, wherein the step of generating a numerical value predictive of a harmful outcome is based on a single writing.

23. The method of claim 21, wherein the ambivalent hostility value and conceptual complexity value are determined using an automated writing analyzer.

24. The method of claim 21, wherein the at least one additional communication comprises one or more of an email communication and a telephone communication.
